(19) United States
(12) Patent Application Publication
(10) Pub. No.: US 2021/0026893 A1
(43) Pub. Date: Jan. 28, 2021

(54) SYSTEM AND METHOD FOR IMPROVING GEOCODING PERFORMANCE

(71) Applicant: Pitney Bowes Inc., Shelton, CT (US)

(72) Inventors: Nishant Sinha, Noida (IN); Neena Priyanka, Noida (IN); Michael Ashmore, Boulder, CO (US)

(73) Assignee: Pitney Bowes Software Inc., Troy, NY (US)

(21) Appl. No.: 16/520,517

(22) Filed: Jul. 24, 2019

(51) Int. Cl. G06F 16/909

(52) U.S. Cl. CPC G06F 16/909

(57) ABSTRACT

A geocoding system and method to convert address elements into numbers to match reference data transformed into numeric values and corresponding spatial information is provided. The output of this process is a conversion of an identified address into its address constituents along with a set of geographic coordinate pairs. A set of build rules are applied to construct the reference data with numeric values, so that when matching is performed, the same address output is displayed along with a pair of geographic coordinates. The reference data consists of number codes along with indexes of boundaries, street segments and address points derived from multiple sources. The numeric match method guarantees exact/close match with quick candidate retrieval and no instance of an input address is erroneously represented in output candidate return.

### FIELD OF THE INVENTION

The invention relates to the field of geocoding and more particularly to a method and apparatus for geocoding with improved performance and accuracy of candidate match return through a number based input/output match.

### BACKGROUND OF THE INVENTION

Geocoding is a process of transforming and translating non-spatial location descriptive text, commonly referred to as an address, into a valid spatial representation by comparing location-specific elements to those in reference data. More specifically, geocoding involved programmatically assigning x and y coordinates (usually, but not limited to, earth coordinates—i.e., latitude and longitude) to records, lists and files containing location information (full addresses, partial addresses, zip codes, etc.). The geocoding process is typically based on the following characteristics: (i) Reference data: consisting of the geographically coded information which will serve as a base to derive the appropriate geographic code for some, (ii) the addresses to be assigned with a geographical reference: the address a user wishes to have geographically referenced and which contains attributes capable of being matched to the reference (iii) Output: geographic coordinates with precision results, and (iv) a decision algorithm: the methodology employed to get a match with the reference data by the process that includes address parsing, normalization, and weighting of the input dataset with that of the reference dataset.

A reference data library is compiled from a variety of sources which range from administrative information, postal addresses, census information, street vectors, Point of Interests (POIs) and ancillary information on location geometry which constitutes a physical address. When an input address is given, the reference data library is searched to fined matches to an ever decreasing precision geographic hierarchy of point, line or polygon boundary until a preset tolerance for a suitable match is met.

The search process for an address can be explained in a simplified manner as follows. To search for address “951 Spruce St, Louisville, Colo. 80027, USA”, the geocoder process must perform a hierarchy of text search and match from the highest to the lowest administrative levels followed by street searches and house number. The search navigates in hierarchy from country, state, district, city, postcode, street, house number and unit number to derive best match as an output. The amount of data scanned for matches mandates a highly efficient system with a fast candidate retrieval. With text based searches and matches the efficiency for fast candidate retrieval is not optimized.

To date, various geocoding software return output candidates based on string match algorithms. As a result, matching and weighting takes time before providing the best match candidate. Further, the complexity increases in order to retrieve exact/close matches if variations exist in the provided input address. There is a need for a more accurate solution that enables quick candidate matches to be determined and provided to the user.

### SUMMARY OF THE INVENTION

According to embodiments of the invention, an automated computer geocoding system that improves the geocoder performance in comparison to traditional functionality of geocoding software is provided. The present invention utilizes a best candidate return in conjunction with a matched geocoded location for given geographic boundaries through number matching instead of string matching to achieve positional accuracy not currently obtainable in the prior art.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, by way of example serve to explain the invention in more detail. As shown throughout the drawings, like reference numerals designate like or corresponding parts.

FIG. 1 illustrates in block diagram form a geocoding system that uses number matching according to an embodiment of the present invention;

FIG. 2 illustrates in flowchart form a geocoding method according to an embodiment of the present invention;

FIGS. 3A-3C illustrate examples of the process flow for an example of the geocoding method in accordance with an embodiment of the invention; and

FIG. 3D illustrates an example of an output in the form of a geocoded coordinate pair and the parsed, standardized and validated output location.

### DETAILED DESCRIPTION OF THE PRESENT INVENTION

The geocoding process has undergone marked transitions to accommodate and exploit changes in parsing, normalization, and weighting to return the best match. Despite progress made in the process, the performance of matching and retrieval is slow, due to the time required to perform text to text based matching across the input candidate and reference data. As set forth above, prior art geocoding methods and apparatus are dependent on string matching between input and reference data for the best candidate retrieval. The processing time to perform string matching as compared with number matching is quite significant. This is because text-based searches require thorough scans of characters looking for instances of a given match and weights need to be assigned for variations to output the best possible candidate.

In accordance with the present invention, to provide the best candidate return (exact/close), input strings can be converted to numbers to match reference records and hence retrieval will be faster and more efficient, without requiring much effort in an underlying georeferenced address dictionary.

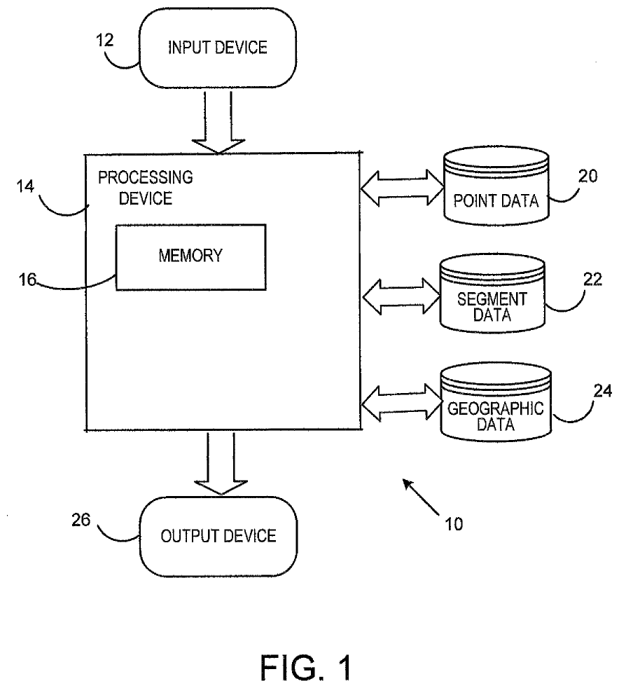

Reference is now made to FIG. 1. A geocoding system 10 includes an input device 12. The input device 12 can be, for example, a keyboard or other input system. The input can also be from another module in a larger system that requires information from the geocoding system 10. The input device 12 is connected to a processing device 14. The processing device 14 is connected to operate in conjunction with a database 20 containing a linear-based or line-based reference dataset, a database 22 containing a point reference dataset, and a database 24 containing general geographic data. General geographic data may include any kind of defined political, postal, regional, or natural area. For example, general geographic area data might include data describing cities, zip codes, national parks, or the like. The processing device 14 includes or has access to a program store or memory device 16 which causes the processing device 14 to process information from one or more of the databases 20, 22, 24 and operate in the manner described herein. Input data is received from the input device 12 of the address for which corresponding geographic coordinates are wished to be known. The processing device 14 outputs the processed information to an output device 26. The output device 26 may be a monitor, a printer, or another output device, or an input to another module in a larger system.

The reference data stored in databases 20, 22, 24 is an important component of any geocoder system because the addresses that are input and locations that are eventually derived are matched against a set of attribute values of the reference data. Point data in database 20 are datasets where a single latitude and longitude is provided for a specific address. Segment data in database 22 are datasets where a street segment line, often as a street centerline, is provided and interpolation is employed to relate the street centerline to a specific address for the address. Parity rules such as odd and even addresses lying on different sides of the street segment can also be employed. The street segment centerline dataset in database 22 contains coordinates that describe the shape of each street and usually the range of house numbers found on each side of the street. The geocoding system 10 may compute a location for an address by linear interpolation of the street number with respect to the street address range. Other types of interpolation may also be used, such as squeeze distance (which might, for example, take into account a known characteristic that addresses are closer together at one end of the segment) and parity rules to determine a physical location for an address. The point level datasets in database 20 result in higher quality addresses accuracy than those requiring the interpolation technique. The geographic dataset in database 24 will typically include data describing the geographic boundaries of different regions. For example, it might include the boundaries of different municipalities or zip code areas. If an address cannot be located in the point database 20 or the segment database 22, then a corresponding location may be assigned as being somewhere in a city, or zip code that is included in the address. Typically the corresponding location that is selected will be a centroid of that geographic area. Determination of a physical location by using this data will most often result in the biggest potential offset distance, but may still be useful for many purposes. The segment data in database 22 is a group of street segments. Each street segment contains a group of latitudes and longitudes (i.e., a group of ordered points), and there is assumed to be a sub-street segment of the street in a straight line between the two points at the end of each street segment. A street segment must have at least two points, but can have many points. Most street segments contain a house number range (an address range) and reverse geocoding to a street segment works by interpolating the house number based on the house number range. The point data in database 20 is a group of point data locations, which are, essentially, latitudes and longitudes of the rooftops of addresses. This data allows precise pinpointing of an address to an exact location, whereas the street segment data above requires interpolation. This is not necessary for a point data match. There is usually only one house number associated with a point in the point data. When there are multiple house numbers, it means the point is a feature such as a high rise building, in which case a convention may be implemented such as returning as a match the lowest available unit. The reference data stored in databases 20, 22, 24 can be built similar to conventional approaches, and according to the present invention changes as described below are made to the database construction.

The point reference dataset stored in database 20, including attributes such as, for example, postal, address and geography point, is composed of point features with required geocoding attributes as illustrated in Tables 1-3 below.

TABLE 1
Typical attributes for Postal Point reference datasets

| Field | Description |
|---|---|
| Country Code (ISO3) | Three letter (ISO3) country code |
| Postcode | Postal code |
| Town name | A name representing the town |
| District Name | A name representing the district |
| State Name | A name representing the state |
| X_Coord (WGS-84) | Longitude values of point |
| Y_Coord (WGS-84) | Latitude values of point |
| Geometry | Point feature geometry |

TABLE 2
Typical attributes for Address Point reference datasets

| Field | Description |
|---|---|
| Country Code (ISO3) | Three letter (ISO3) country code |
| Address ID | Address point identifier |
| House Number | House number value |
| Building name | A name representing building |
| Landmark | A name representing landmark |
| Street Name | Name of street |
| Street Name alias | Alias/Alternate name of street |
| Postcode | Postal Code |
| City Name | A name representing city |
| City Name Alias | A name representing city name alias |
| District Name | A name representing district |
| District Alias Names | A name representing district name |
| | alias |
| State Name | A name representing state |
| State Alias Names | A name representing state name |
| | alias |
| X_Coord (WGS-84) | Longitude values of point |
| Y_Coord (WGS-84) | Latitude values of point |
| Geometry | Point feature geometry |

TABLE 3
Typical attributes for Geography Point reference datasets

| Field | Description |
|---|---|
| Country ISO2 (ISO2) | Two letter (ISO2) country code |
| Country ISO3 (ISO3) | Three letter (ISO3) country code |
| Country Name | Name of country |
| Town Name | A name representing the town |
| District Alias Names | A name representing town name |
| | alias |
| District Name | A name representing district |
| District Alias Names | A name representing district name |
| | alias |
| State Name | A name representing state |
| State Alias Names | A name representing state name |
| | alias |
| X_Coord (WGS-84) | Longitude values of point |
| Y_Coord (WGS-84) | Latitude values of point |
| Geometry | Point feature geometry |

A linear-based or line-based reference dataset, as stored in database 22, is composed of lines/polylines features with required geocoding attributes as illustrated in Table 4 below.

TABLE 4
Typical attributes for the linear (line/polyline) reference datasets

| Field | Description |
|---|---|
| Country Code (ISO3) | Three letter (ISO3) Country Code |
| Street name | Name of street |
| Street alias name | Alias/Altemate Name of street |
| Street Type | Type of street |
| Street Prefix Directional | Street directional indicator |
| Street Post Directional | Street directional indicator |
| Language code | Language code of street name |
| Start house number on left | Beginning of the address range for |
| | left side of the street segment |
| End house number on left | End of the address range for left side |
| | of the street segment |
| Start house number on right | Beginning of the address range for |
| | right side of the street segment |
| End house number on right | End of the address range for right |
| | side of the street segment |
| Postal Code Left side of street | A code representing the postcode |
| | value for the left side |
| Postal Code Right side of street | A code representing the postcode |
| | value for the right side |
| Left Locality name | A name representing the locality on |
| | the left side |
| Right Locality name | A name representing the locality on |
| | the right side |
| Left Town | A name representing the town on the |
| | left side |
| Right Town | A name representing the town on the |
| | right side |
| Left District | A name representing the district on |
| | the left side |
| Right District | A name representing the district on |
| | the right side |
| Left State | A name representing the state on the |
| | left side |
| Right State | A name representing the state on the |
| | right side |
| Left Built-up area name | A name representing the built-up |
| | area on the left side |
| Right Built-up area name | A name representing the built-up |
| | area on the right side |
| Street Geometry | Linear feature geometry |

According to the present invention, some additional fields, such as for example, Base Value, ASCII Code values, logarithmic values (at base 10) and threshold value fields as shown in Table 5 have been calculated based on a conversion function as described below and are added to the datasets that are stored in databases 20, 22, 24 in respective data tables such as geography points, postal points, address points, street segments, etc.

TABLE 5
Typical attributes for the point reference datasets
(such as postal points/address points)

| Field | Description |
|---|---|
| Base Value | Value which will form base of different feature types |
| ASCII Code | A code representing English characters as numbers |
| Logarithmic | Calculated Log value of ASCII Code at base 10 |
| Value | |
| Threshold | Variation value range for respective name fields |
| Range | |

The base value will be used as a starting value to which the ASCII code is concatenated for the Logarithmic Value calculation. The base values are designed to keep a variability factor in address components like aliases, phonetics, transliterations, etc., and were determined based on different permutations and combinations to handle names and its aliases. The base numbers are kept large enough to differentiate across address elements when log values are calculated. The base value will differentiate address elements log values and will be useful in traversing address elements searches in hierarchical fashion as the search result will narrow down from the country to the lowest level of hierarchy. Various base value levels defined are listed below in Table 6. These values have been determined based on different permutations and combinations as noted above. Geographic addresses of various countries were analyzed and various geocoding address examples were worked out to determine proper base values.

TABLE 6
Base Value for concatenating ASCII value for Logarithmic Value calculation

| | Base Value (Start & End Ranges and No. |
|---|---|
| Address Elements | of placeholder for respective address elements) |
| Country (text) | 33 digits (Last 3 digits are for handling Aliases) |
| | Series Starts at: 999,999,999,999,999,999,999,999,999,001,000 |
| | Series Ends at: 999,999,999,999,999,999,999,999,999,999,000 |
| | 998 placeholder for country name |
| State/or Equivalent (text) | 30 digits (Last 3 digits are for handling Aliases) |
| | Series Starts at: 999,999,999,999,999,999,999,001,000,000 |
| | Series Ends at: 999,999,999,999,999,999,999,999,999,000 |
| | 999,998 placeholder for state name |
| County/or Equivalent | 27 digits (Last 3 digits are for handling Aliases) |
| (text) | Series Starts at: 999,999,999,999,999,999,001,000,000 |
| | Series Ends at: 999,999,999,999,999,999,999,999,000 |
| | 999,998 placeholder for county name |
| City/Town/Locality/or | 24 digits (Last 3 digits are for handling Aliases) |
| Equivalent (text) | Series Starts at: 999,999,999,999,001,000,000,000 |
| | Series Ends at: 999,999,999,999,999,999,999,000 |
| | 999,999,998 placeholder for city/town/locatity name |
| Postcode (number) | 21 digits (Last 6 digits are for handling zip + 4, |
| | po box, dpc or other postcode additional values) |
| | Series Starts at: 999,999,001,000,000,000,000 |
| | Series Ends at: 999,999,999,999,999,000,000 |
| | 999,999,998 placeholder for postcode/zips |
| Street Name (text) | 18 digits (Last 3 digits are for handling street name aliases/alternate name) |
| | Series Starts at: 999,999,001,000,000,000 |
| | Series Ends at: 999,999,999,999,999,000 |
| | 999,999,998 placeholder for street name |
| Street Type (text) | 15 digits (Last 3 digits are for handling street type aliases) |
| | Series Starts at: 999,999,999,001,000 |
| | Series Ends at: 999,999,999,999,000 |
| | 998 placeholder for street type |
| House Number (text) | 12 digits (Last 3 digits are for handling house number aliases) |
| | Series Starts at: 999,001,000,000 |
| | Series Ends at: 999,999,999,000 |
| | 999,998 placeholder for house number |
| Unit Number (text) | 9 digits |
| | Series Starts at: 999,001,000 |
| | Series Ends at: 999,999,999 |
| | 999,998 placeholder for unit numbers |
| Unit Designator (text) | 6 digits |
| | Series Starts at: 999,001 |
| | Series Ends at: 999,999 |
| | 998 placeholder for unit designators |

The base value will be concatenated with the string ASCII value of the Address Element record and a logarithmic value will be derived. These derived log values will be stored in the database as explained in Table 7 below and further illustrated through an Address string example.

TABLE 7
Example Address String (USA): 951 Spruce St Louisville, Boulder, Colorado 80027 United States

| Address | | ASCII Code | | Logarithmic |
|---|---|---|---|---|
| Elements | Example | Generation | Base Value | Value |
| Country | United | 85 110 105 116 | 999,999,999,999,999,999,999,999,999,001,000 | 68 |
| | States | 101 100 32 83 116 | | |
| | | 97 116 101 115 | | |
| State | Colorado | 67 111 108 111 | 999,999,999,999,999,999,999,001,000,000 | 52 |
| | | 114 97 100 111 | | |
| County | Boulder | 66 111 117 108 | 999,999,999,999,999,999,001,000,000 | 47 |
| | | 100 101 114 | | |
| City | Louisville | 76 111 117 105 | 999,999,999,999,001,000,000,000 | 53 |
| | | 115 118 105 108 | | |
| | | 108 101 | | |
| Postcode | 80027 | — | 999,999,001,000,000,000,000 | 25.999999566 |
| Street | Spruce | 83 112 114 11799 | 999,999,001,000,000,000 | 33.999999566 |
| Name | | 101 | | |
| Street | St | 115 116 | 999,999,999,001,000 | 21 |
| Type | | | | |
| House | 951 | — | 999,001,000,000 | 14.999565923 |
| Number | | | | |

The Address String “951 Spruce St, Louisville, Boulder, Colo., 80027 United States” was parsed into different constituents such as country, state, county, postcode, city, etc. The text string of the address records were converted to ASCII numbers based on alphabet to ASCII lookup values as illustrated in Table 8.

TABLE 8

| Letter | ASCII Code | Binary | Letter | ASCII Code | Binary |
|---|---|---|---|---|---|
| a | 097 | 01100001 | A | 065 | 01000001 |
| b | 098 | 01100010 | B | 066 | 01000010 |
| c | 099 | 01100011 | C | 067 | 01000011 |
| d | 100 | 01100100 | D | 068 | 01000100 |
| e | 101 | 01100101 | E | 069 | 01000101 |
| f | 102 | 01100110 | F | 070 | 01000110 |
| g | 103 | 01100111 | G | 071 | 01000111 |
| h | 104 | 01101000 | H | 072 | 01001000 |
| i | 105 | 01101001 | I | 073 | 01001001 |
| j | 106 | 01101010 | J | 074 | 01001010 |
| k | 107 | 01101011 | K | 075 | 01001011 |
| l | 108 | 01101100 | L | 076 | 01001100 |
| m | 109 | 01101101 | M | 077 | 01001101 |
| n | 110 | 01101110 | N | 078 | 01001110 |
| o | 111 | 01101111 | O | 079 | 01001111 |
| p | 112 | 01110000 | P | 080 | 01010000 |
| q | 113 | 01110001 | Q | 081 | 01010001 |
| r | 114 | 01110010 | R | 082 | 01010010 |
| s | 115 | 01110011 | S | 083 | 01010011 |
| t | 116 | 01110100 | T | 084 | 01010100 |
| u | 117 | 01110101 | U | 085 | 01010101 |
| v | 118 | 01110110 | V | 086 | 01010110 |
| w | 119 | 01110111 | W | 087 | 01010111 |
| x | 120 | 01111000 | X | 088 | 01011000 |
| y | 121 | 01111001 | Y | 089 | 01011001 |
| z | 122 | 01111010 | Z | 090 | 01011010 |

Once the ASCII numbers were obtained, these were concatenated with varying base numbers of parsed elements (derived through permutations and combinations of optimal base value computations). The text marked in bold italics below represents the base value of the parsed elements, for country the base value is different than base value of State or its equivalent hierarchy.
Country: US—99999999999999999999999999900100085110105116101100328311697116101115=68
State: Colorado—9999999999999999999990010000006711110811111497100111=52
County: Boulder—99999999999999999900100000066111117108100101114=47
City: Louisville—99999999999900100000000076111117105115118105108108101=53
Postcode: 80027—99999900100000000000080027=25.999999566
Street Name: Spruce—9999990010000000008311211411799101=33.999999566
Street Type: St—999999999001000115116=21
House Number: 951—999001000000951=14.999565923

The logarithmic value (base 10) was calculated for the concatenated numbers (Base+ASCII). These log values were then stored in the database along with text information for faster lookup and query from the reference dataset. The same log values will be assigned to address element variations for aliases. For example, the Log Value for a Country name and Country ISO3 or Country ISO2 and Aliases will be the same. For example, for the United States, the Country Name is United States, the ISO3 is USA, and the ISO2 is US. All three of these will store the same log value, i.e. 65.

Reference data created as described above with the numeric values calculated based on the conversion function will assist in faster performance and response time as opposed to conventional reference dictionaries. The modified reference dataset is then stored in the databases 20, 22, 24 for use by the geocoding system 10.

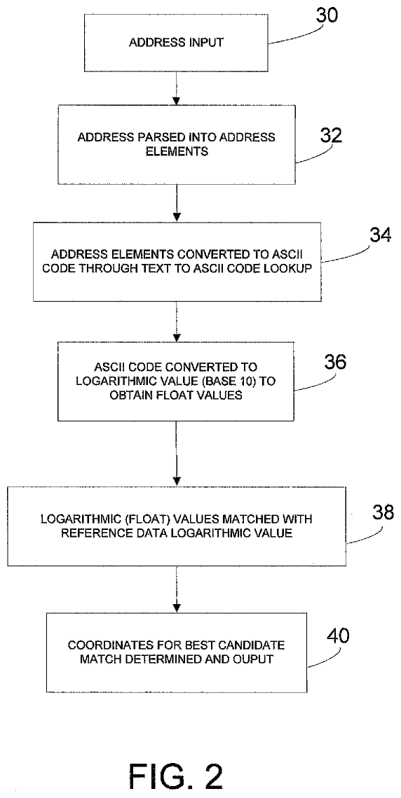

Reference is now made to FIG. 2, where a geocoding method according to an embodiment of the present invention that utilizes the reference dataset built as described above is illustrated in flowchart form. In step 30, an address is input into the geocoder system, using, for example the input device 12. In step 32, the input address is parsed into its constituent address elements, e.g., country, postcode, state, county, city, street type, street name, house number, etc. Once parsing is complete, the parsed elements are converted into numeric values using the conversion function as described above. More specifically, ASCII codes are determined as described above for these address elements in step 34. In step 36, the ASCII codes are concatenated with parsed base values and then logarithmic value (base 10) conversion is done to obtain float values. In step 38, these float values are matched against the log values of the reference data stored in databases 20, 22, 24. The value match preferably starts from the highest administrative boundaries, such as country value match, to the lowest address point, for example, house number match, in a tree and branch fashion. This simplifies the procedure for scanning through the entire datasets of databases 20, 22, 24 to derive an output. Once a match is found, in step 40 the best candidate is provided as an output, using, for example, the output device 26, with a pair of corresponding coordinates for the input address. The output address is preferably normalized, standardized and verified if a match is found.

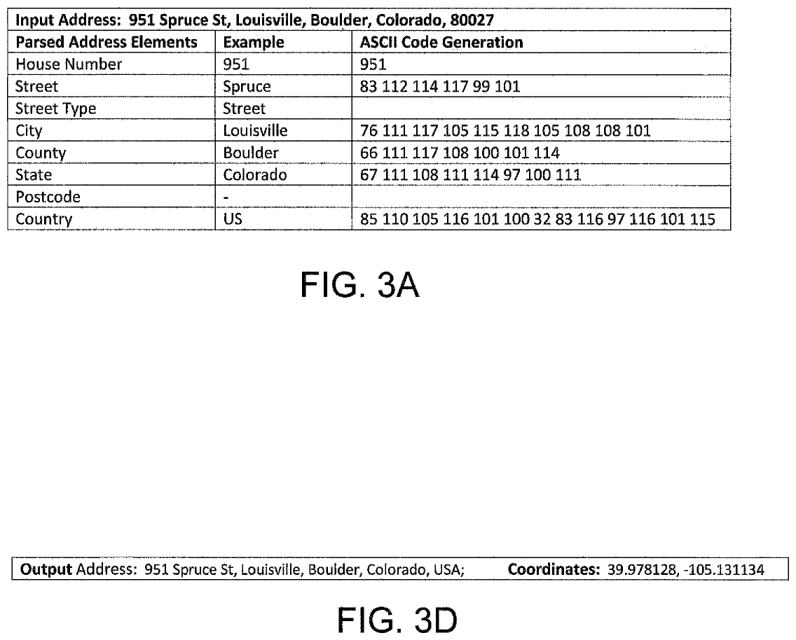

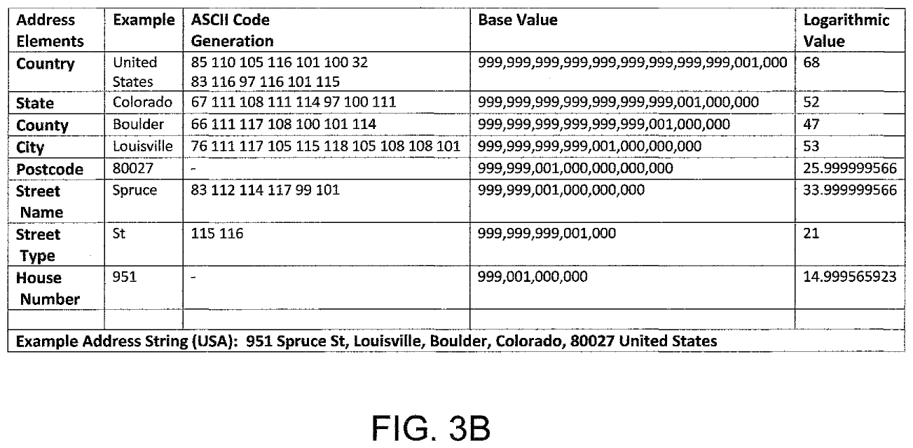

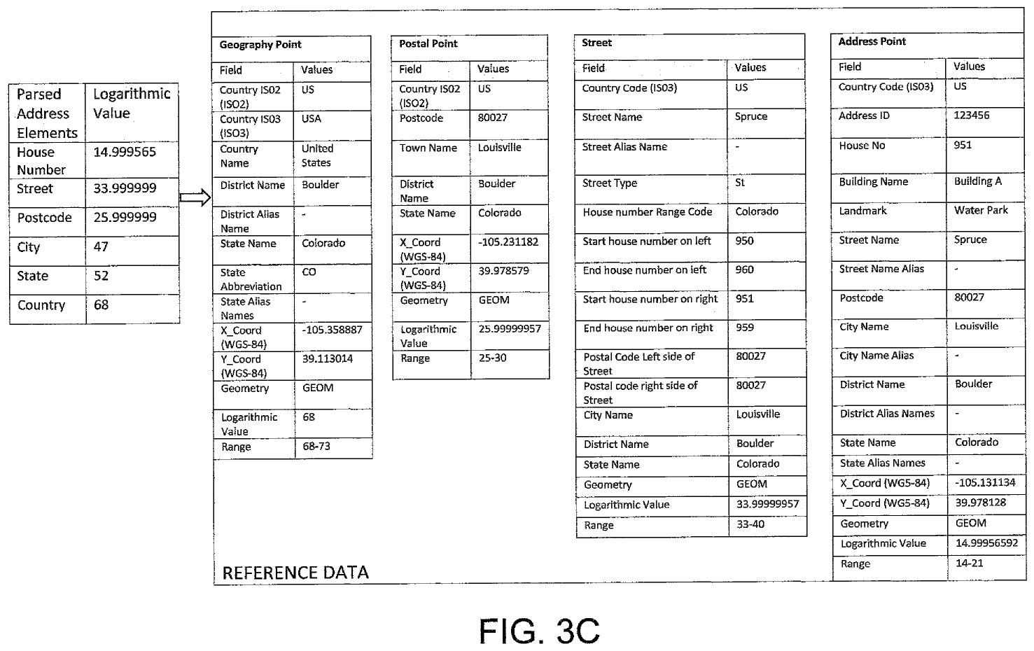

FIGS. 3A-3C illustrate an example of the geocoding described in FIG. 2 in accordance with an embodiment of the invention. The process begins by inputting an address to be geocoded, i.e. the “input address” (FIG. 2, Step 30). For example, the input address is 951 Spruce Street, Louisville, Colo. The process parses the input address into its constituent address elements (FIG. 2, Step 32). For example, the input address is parsed into country (US), state (Colorado), county (Boulder), city (Louisville), street type (street), street name (Spruce) and house number (951). These address elements are converted into ASCII code through a text to ASCII code lookup (FIG. 2, Step 34). The result is illustrated in FIG. 3A. The ASCII codes are then concatenated with base value for logarithmic conversion to obtain the float values (FIG. 2, Step 36). The result is illustrated in FIG. 3B. The log values (Base 10) of these concatenated numbers are then stored in memory such as memory device 16. The logarithmic values for the input address are then matched with the reference data logarithmic values stored in the databases 20, 22, 24 (FIG. 2, Step 38) as illustrated in FIG. 3C. The log value matching process begins with matching the highest administrative level, i.e., country log value, to the reference data. Numeric matching is easier as opposed to an array of strings and hence the processing device is able to more quickly retrieve potential candidate matches. Thus, the operation of the processing device 14 is improved over the prior art. Once a match is found for the country log value, the next administrative level numeric value, i.e., state, is scanned for a match. With each hierarchical number match, the number of scanned addresses reduces and hence eliminates the need for an entire geography/street/address points match. The lowest number in this match is for the house number, and once an exact/close match is found in the reference data, the output candidate is returned without the exercise of weight calculation for possible matches. Along with the output address match, a coordinate pair comprising latitude/longitude is retrieved based on a geocoding engine algorithm, which can be any geocoding process that devices coordinate pairs. According to an embodiment of the invention, the process continues in a hierarchical fashion with number to number match to determine an exact/close match. The process terminates with output of the results in the form of a geocoded coordinate pair and the parsed, standardized and validated output location, i.e., 951 Spruce Street, Louisville, Boulder, Colo. 80027 USA; Coordinates: 39.978128, −105.131134, as illustrated in FIG. 3D.

Thus, using the geocoding process of the present invention results in a faster output candidate retrieval based on the combination of the geocoding process and pre-calculated numeric values in the reference data. While preferred embodiments of the invention have been described and illustrated above, it should be understood that they are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. In an automated computer geocoding system having a plurality of reference geographic datasets each containing a plurality of data points stored in a database, wherein the reference geographic datasets include numeric values calculated based on a conversion function for each of the plurality of data points, a method for determining a set of geographic coordinates of a location, the method comprising:
receiving by the geocoding system information associated with the location;
parsing the information associated with the location into a plurality of address elements;
converting each of the plurality of address elements into a numeric value based on the conversion function;
determining a best match candidate for the location by searching the reference geographic datasets for data points that match the numeric value of the address elements;
obtaining the set of geographic coordinates for the determined best match; and
outputting the obtained set of geographic coordinates.

2. The method of claim 1, wherein converting each of the plurality of address elements into a numeric value based on the conversion function further comprises:
determining an ASCII code for each of the address elements;
concatenating each ASCII code with a predetermined base value code; and
obtaining a logarithmic value as the numeric value.

3. The method of claim 1, wherein the plurality of reference geographic datasets include a point level dataset, a street level dataset, and a geographic level dataset.

4. An automated computer geocoding system comprising:
a plurality of reference geographic datasets each containing a plurality of data points stored in a database, wherein the reference geographic datasets include numeric values calculated based on a conversion function for each of the plurality of data points; and
a processing device, the processing device being configured for:
receiving information associated with a location to be geocoded;
parsing the information associated with the location into a plurality of address elements;
converting each of the plurality of address elements into a numeric value based on the conversion function;
determining a best match candidate for the location by searching the reference geographic datasets for data points that match the numeric value of the address elements;
obtaining a set of geographic coordinates for the determined best match; and
outputting the obtained set of geographic coordinates.

5. The system of claim 4, wherein the plurality of reference geographic datasets include a point level dataset, a street level dataset, and a geographic level dataset.
